(19) United States
(12) Patent Application Publication
(10) Pub. No.: US 2021/0205166 A1
(43) Pub. Date: Jul. 8, 2021

(54) Walking Aid for a Pet

(71) Applicant: HUI CHU LAICHENG, Taichung (TW)

(72) Inventor: HUI CHU LAICHENG, Taichung (TW)

(21) Appl. No.: 16/733,059

(22) Filed: Jan. 2, 2020

(51) Int. Cl. A61H 3/04; A01K 13/00

(52) U.S. Cl. CPC A61H 3/04; A61H 2003/007; A61H 2203/03; A01K 13/00

(57) ABSTRACT

A walking aid for a pet includes a main member having a front opening and a rear opening to form a chamber between the front opening and a rear opening. A plurality of wheels mounted on a bottom side of the main member. A connecting member has an end connected to the main member and extending to the chamber, wherein the connecting member has a first connector. A supporting member has a second connector, wherein the supporting member is received in the chamber of the main member with the second connector connecting the first connector of the connecting member.

### BACKGROUND OF THE INVENTION

### 1. Technical Field

The present invention relates to a gear for pets, and more particularly to a walking aid for a pet.

### 2. Description of Related Art

Some conventional walking aids for pets are huge and heavy, and they usually are expansive. Therefore, some pet owners choose to give up the pets instead of buying a walking aid. There were small and light walking aids in the market. However, they are suitable for small pets only.

Another conventional walking aid includes a supporting member with two ropes connected to the supporting member. The supporting member is placed under abdomen of a pet, and pet owner holds the ropes to lift the pet a little so that the pet may walk with the help of the owner.

It is easy to understand that it is a tough job for the pet owner to walk the pet for a long time, especially when he/she walks a large pet.

In conclusion, a safer and cheaper walking aid for pets is very welcome in the present market.

### BRIEF SUMMARY OF THE INVENTION

In view of the above, the primary objective of the present invention is to provide a walking aid for a pet, which is safer and cheaper than the conventional walking aids.

In order to achieve the objective of the present invention, a walking aid for a pet includes a main member having a front opening and a rear opening to form a chamber between the front opening and a rear opening. A plurality of wheels mounted on a bottom side of the main member. A connecting member has an end connected to the main member and extending to the chamber, wherein the connecting member has a first connector. A supporting member has a second connector, wherein the supporting member is received in the chamber of the main member with the second connector connecting the first connector of the connecting member.

In an embodiment, the walking aid for a pet further includes a holding member, having an end connected to the main member and extends to the chamber of the main member; wherein the holding member has a first coupler, and the supporting member has a second coupler; the holding member is connected to the supporting member with engagement of the first coupler and the second coupler when the supporting member is received in the chamber of the main member.

In an embodiment, the first coupler and the second coupler are a pair of a hook fastener and a loop fastener of Velcro.

In an embodiment, the first connector and the second connector are a pair of a female buckle member and a male buckle member of a side release buckle.

In an embodiment, the main member has two cases and a fastener, and the fastener connects the cases to form the main member.

In an embodiment, the main member has a top side, a front side, a rear side, two lateral sides, and a bottom side; the front side has the front opening, and the rear side has the rear opening.

In an embodiment, the main member further has a bottom opening on the bottom side; both the front opening and the rear opening connect the bottom opening.

In an embodiment, the walking aid for a pet further includes a strip having an end connected to the main member.

In an embodiment, the walking aid for a pet further includes a ring connected to the main member.

In an embodiment, the supporting member is provided with a first fastener and a second fastener, and the first fastener engages the second fastener when the supporting member is warped.

In an embodiment, the first fastener and the second fastener are a pair of a hook fastener and a loop fastener of Velcro provided on opposite sides of the supporting member.

The present invention provides the walking aid for pet, which could provide for a pet a safer and cheaper walking aid.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the main member of a first preferred embodiment of the present invention;

FIG. 2 is another perspective view of the main member of the first preferred embodiment of the present invention;

FIG. 3 is a perspective view of the main member of a second preferred embodiment of the present invention;

FIG. 4 is a perspective view of the supporting member of the first preferred embodiment of the present invention;

FIG. 5 is a perspective view of the first preferred embodiment of the present invention; and

FIG. 6 is a sketch diagram of the first preferred embodiment of the present invention, showing a pet wearing the walking aid.

### DETAILED DESCRIPTION OF THE INVENTION

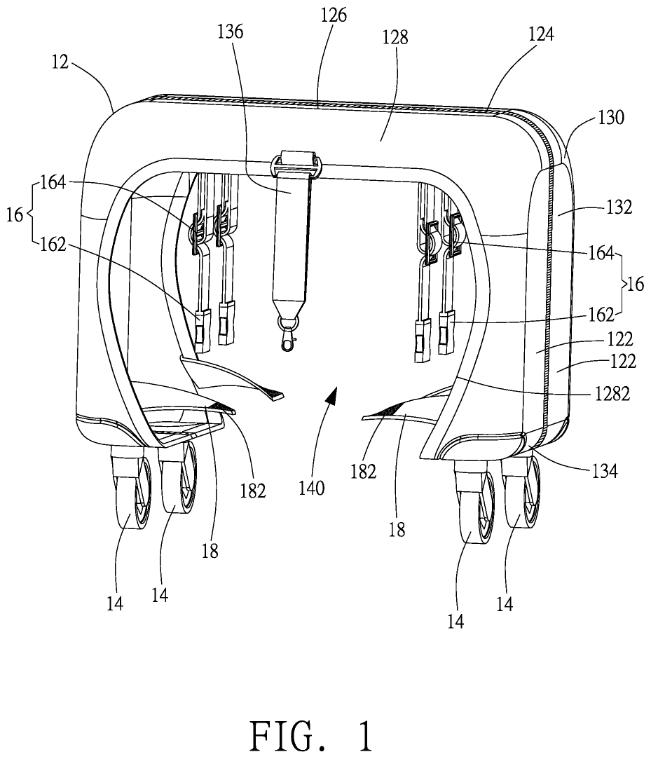

FIG. 1 shows a walking aid for a pet of the first preferred embodiment of the present invention, including a main member 12, four wheels 14, four connecting members 16, four holding members 18, and a supporting member 20.

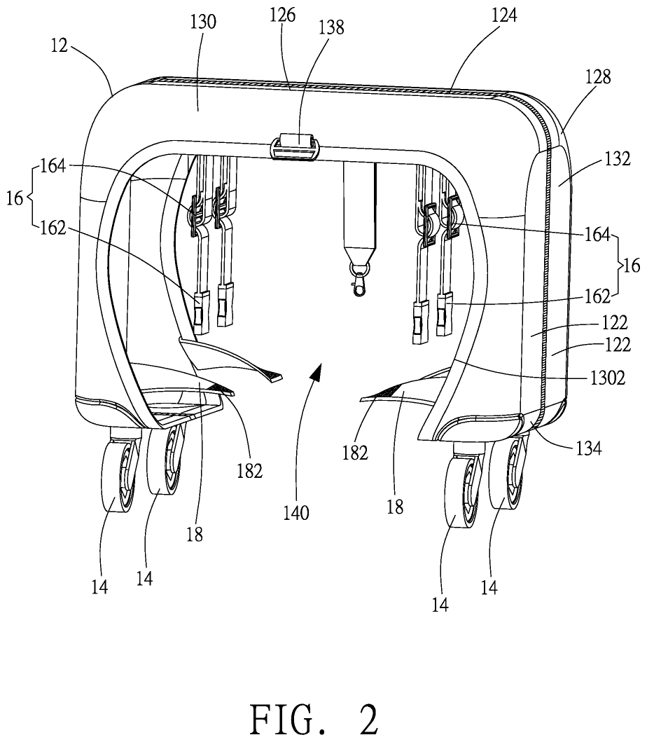

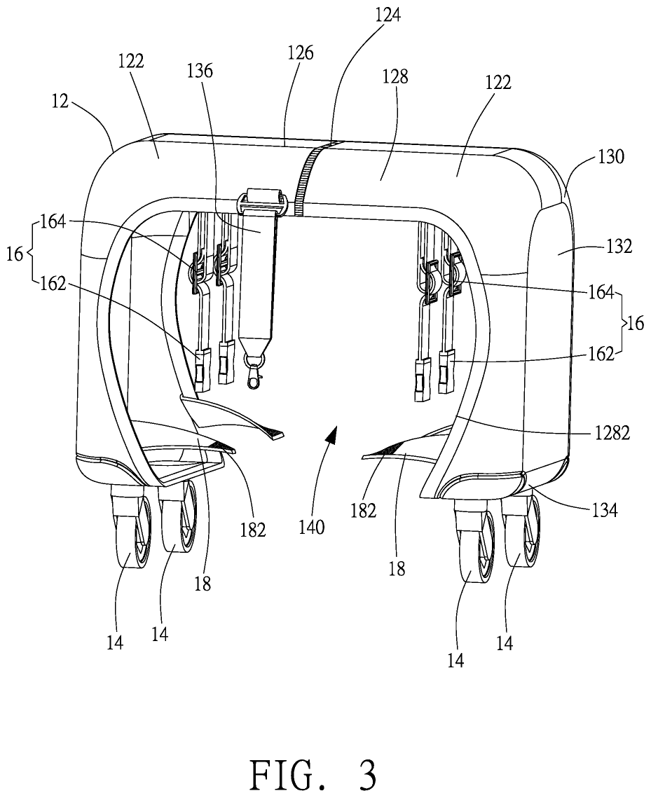

As shown in FIG. 1 and FIG. 2, the main member 12 has two cases 122 and a fastener 124 connecting the cases 122 to form the main member 12. The cases 122 may be a front case and a rear case (FIGS. 1 & 2), or a right case and a left case (FIG. 3). In another embodiment, the main member 12 may be made into a single element (not shown). In the first preferred embodiment, the main member 12 has a top side 126, a front side 128, a rear side 130, two lateral sides 132, and a bottom side 134. The top side 126 has four ends connected to ends of the front side 128, the rear sides 130, and the lateral sides 132, and the bottom side 134 has four ends connected to opposite ends of the front side 128, the rear sides 130, and the lateral sides 132. The top side 126 is opposite to the bottom side 134, the front side 128 is opposite to the rear side 130, and the lateral side 132 is opposite to the other lateral side 132. The front side 128 is provided with a front opening 1282, the rear side 130 is provided with a rear opening 1302, and the bottom side 134 is provided with a bottom opening 1342. Both the front opening 1282 and the rear opening 1302 are connected to the bottom opening 1342 to form the archway-like main member 12. The main member 12 has a chamber 140 between the front opening 1282 and the rear opening 1302. The main member 12 is provided with a strip 136 on the front side 128 above the front opening 1282 and a ring 138 on the rear side 130 above the rear opening 1302.

The wheels 14 are provided at four corners of the bottom side 134 of the main member 12.

The connecting members 16 are belts with ends connected to an interior side of the top side 126 of the main member 12 and extending to the chamber 140 of the main member 12. Each of the connecting members 16 has a first connector 162 on a distal end thereof and an adjusting device 164. Operating the adjusting device 164 may elongate or shorten the connecting member 16.

The holding members 18 are four belts as well, two of which are connected to an interior side of the front side 128 at a right and a left sides of the front opening 1282, and the other two of which are connected to an interior side of the rear side 130 at a right and a left sides of the rear opening 1302. Each of the holding members 18 has a first coupler 182 at a distal end thereof. All the holding members 18 extend to the chamber 140 of the main member 12.

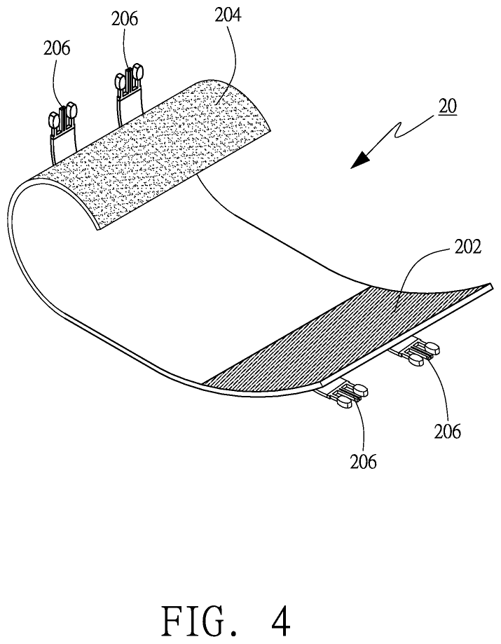

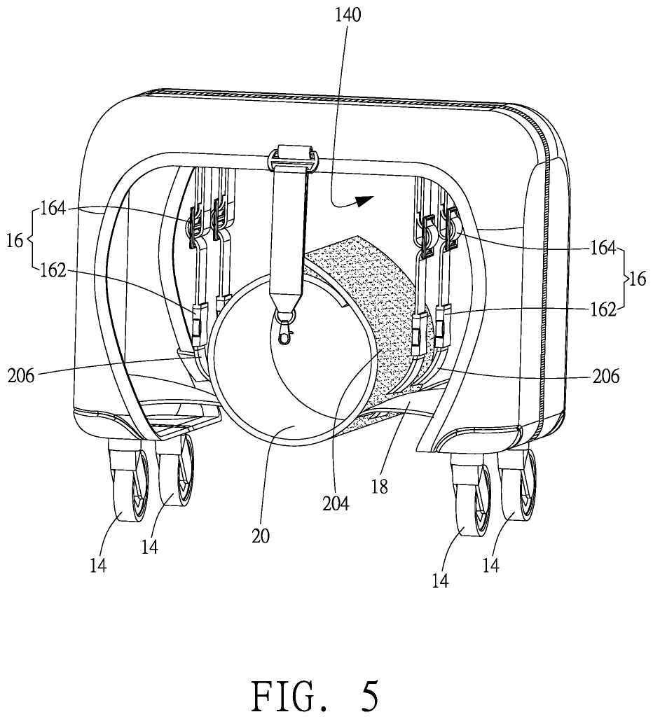

As shown in FIG. 4 and FIG. 5, the supporting member 20 is a blanket-like flexible member having a first fastener 202 on a side and a second fastener 204 on the other side. The supporting member is able to be warped for the first fastener 202 engaging the second fastener 204 to keep the supporting member 20 in a ring shape (FIG. 5). In the present embodiment, the first fastener 202 and the second fastener 204 are a hook fastener and a loop fastener of Velcro. The supporting member 20 further is provided with second connectors 206 and second couplers 204. The second connectors 206 are designated to engage the first connectors 162 respectively, and the second couplers 204 are designated to engage the first couplers 182 respectively. In the present embodiment, the first and the second connectors 162, 206 are a pair of a female buckle member and a male buckle member of a side release buckle, and the first and the second couplers 182, 204 are a hook fastener and a loop fastener of Velcro. The second fastener and the second coupler are the same element, the loop fastener of Velcro.

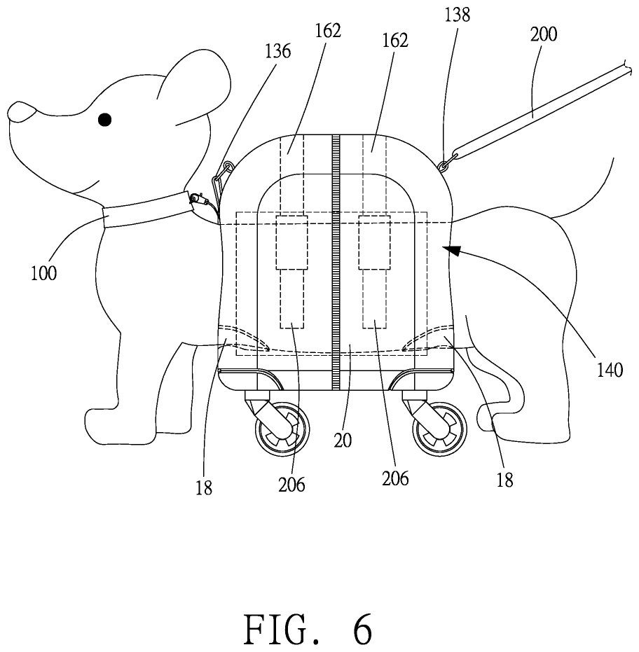

As shown in FIG. 6, the supporting member 20 is surrounded on a trunk of a pet and fixed by engagement of the first fastener 202 and the second fastener 204. Next, move the pet into the chamber 140 of the member 12, and then connect the first connectors 162 of the connecting members 14 to the second connectors 206 of the supporting member 20, and connect the first couplers 182 of the holing members 18 to the second couplers 204 at abdomen portion of the pet. The strip 136 may be connected to a collar 100 of the pet, and the owner may connect a rope 200 to the ring 140. With adjustment of the adjusting device 164 to change lengths of the connecting member 16 and a support of the holding members 18, the pet may be supported by the main member 12. Pet owner may hold the rope 200 to walk the pet.

It must be pointed out that the embodiments described above are only some preferred embodiments of the present invention. All equivalent structures which employ the concepts disclosed in this specification and the appended claims should fall within the scope of the present invention.

What is claimed is:

1. A walking aid for a pet, comprising:
a main member having a front opening and a rear opening to form a chamber between the front opening and a rear opening;
a plurality of wheels mounted on a bottom side of the main member;
a connecting member having an end connected to the main member and extending to the chamber, wherein the connecting member has a first connector; and
a supporting member having a second connector, wherein the supporting member is received in the chamber of the main member with the second connector connecting the first connector of the connecting member.

2. The walking aid of claim 1, further comprising a holding member, having an end connected to the main member and extends to the chamber of the main member; wherein the holding member has a first coupler, and the supporting member has a second coupler; the holding member is connected to the supporting member with engagement of the first coupler and the second coupler when the supporting member is received in the chamber of the main member.

3. The walking aid of claim 2, wherein the first coupler and the second coupler are a pair of a hook fastener and a loop fastener of Velcro.

4. The walking aid of claim 1, wherein the first connector and the second connector are a pair of a female buckle member and a male buckle member of a side release buckle.

5. The walking aid of claim 1, wherein the main member has two cases and a fastener, and the fastener connects the cases to form the main member.

6. The height adjustable desk of claim 1, wherein the main member has a top side, a front side, a rear side, two lateral sides, and a bottom side; the front side has the front opening, and the rear side has the rear opening.

7. The walking aid of claim 6, wherein the main member further has a bottom opening on the bottom side; both the front opening and the rear opening connect the bottom opening.

8. The walking aid of claim 1, further comprising a strip having an end connected to the main member.

9. The walking aid of claim 1, further comprising a ring connected to the main member.

10. The walking aid of claim 1, wherein the supporting member is provided with a first fastener and a second fastener, and the first fastener engages the second fastener when the supporting member is warped.

11. The walking aid of claim 10, wherein the first fastener and the second fastener are a pair of a hook fastener and a loop fastener of Velcro provided on opposite sides of the supporting member.
